(19) United States
(12) Patent Application Publication
(10) Pub. No.: US 2024/0351283 A1
(43) Pub. Date: Oct. 24, 2024

(54) SYSTEM AND METHOD FOR STEREOLITHOGRAPHIC PRINTING

(71) Applicant: DWS S.R.L., Thiene (VI) (IT)

(72) Inventor: Ettore Maurizio COSTABEBER, Zanè (VI) (IT)

(73) Assignee: DWS S.R.L., Thiene (VI) (IT)

(21) Appl. No.: 18/684,874

(22) PCT Filed: Aug. 19, 2022
(86) PCT No.: PCT/IB2022/057784

§ 371 Date: Feb. 20, 2024

(30) Foreign Application Priority Data
Aug. 20, 2021 (IT) 102021000022145

(51) Int. Cl. B29C 64/245; B29C 64/124; B33Y 10/00; B33Y 30/00

(52) U.S. Cl. CPC B29C 64/245; B29C 64/124; B33Y 10/00; B33Y 30/00

(57) ABSTRACT

System for stereolithographic printing comprising a support structure which defines a reference plane on which a three-dimensional object is formed starting from at least one material sensitive to the basic radiation adapted to be solidified when irradiated by a radiation, means for generating such radiation in the direction of such reference plane, a modelling plate which supports and to which the three-dimensional object being formed is constrained, which is able to move the solidified layer according to a direction substantially perpendicular to such plane, so as to allow the last solidified layer of the object to be arranged in a position adjacent to said plane, means for forming at least one layer of such radiation-sensitive material on such reference plane including at least a portion of a film that can be moved on said plane from one end to the other of said plane and a first feeder of a first radiation-sensitive material on said portion of film. Such forming means comprise at least a first pair of substantially vertically mobile barriers each arranged in proximity to one of these ends of the plane, the distance between these elements determining the width of the reference plane and such modelling plate moving substantially vertically between the mobile barriers. Such forming means comprise, externally to the mobile barriers with respect to the plane, a pair of scrapers which strike the film with their tip and such barriers being movable at least between a first raised position at a height predetermined by the film and a second position in which the lower edge of the barrier is in contact with the film itself. Such film is translatable from one end to the other of said plane in both directions. Such first feeder of such first material on the film is placed in proximity to one of the two barriers, in the space between it and the respective scraper.

The present invention relates to a system and method for stereolithographic printing. “Stereolithography” is a method for generating three-dimensional solid objects by successively “printing” thin layers of such an object on top of each other starting from a solidifiable liquid or pasty material that is exposed to a predefined radiation, usually (but not exclusively) light. This radiation is directed onto a surface or layer of such liquid or pasty material to form a solid cross-section of the object. The object is then moved, in a programmed manner, away from the liquid surface by the thickness of a layer, and the next cross-section is then formed and adhered to the immediately preceding layer, defining the object. This process is continuous until the entire object is formed. Essentially all kinds of object shapes can be created with this technique. Complex shapes are created more easily using the functions of a computer to help create the programmed commands and then send the programme signals to the subsystem forming the stereolithographic object.

A stereolithography machine that performs this method essentially comprises a container containing the fluid substance, generally a radiation-sensitive resin in a liquid or pasty state, a source of such radiation, which is generally of the luminous type, that emits the radiation suitable for solidifying such fluid substance. An optical unit directs said radiation to a reference surface inside the container, which corresponds to the position of the layer of the object to be solidified. The machine further comprises a modelling plate, which supports and to which the three-dimensional object being formed is constrained, and which can be moved vertically relative to the container, so that the last solidified layer of the object can be placed in a position adjacent to said reference surface. After that, the process is repeated for the next layer.

Stereolithography machines in which the resin is spread on a translucent transparent film, rather than in a tank, are also known. The film moves this layer and brings it to a position where it can be reached by the radiation emitted by the source placed for example below the film.

Patent application WO2019243873 describes such a machine and method in which resin is emitted from a moving nozzle onto the film and then transported underneath that source, while another layer of resin is applied in another portion of the film for printing the next layer. Similar technology is described in patent U.S. Pat. No. 5,650,260A, where the resin dispensing means are fixed to one end of the film itself, which transports the layer of resin in proximity to the source of radiation.

Finally, patent application US2018200948A1 describes a machine in which the film is unwound from one roller and rewound onto another. In a rectilinear portion of this film, between the two rollers, the resin is spread by means of a feeder placed adjacent to the unwinding roller, and again in the central rectilinear area of the film, printing is carried out by means of a radiation source placed below the film and a modelling plate placed above the film. The machine also includes a station for recovering resin left on the film and not used for printing, placed adjacent to the roller that rewinds the film. This station feeds the resin back into the feeder tank after a quality check.

The applicant has noted that in such systems, where the resin is placed on a film or generally on a flexible laminar element, it is essential that the film is always in an optimal clean condition. In fact, patent application US2018200948A1 provides a special fixed scraper positioned adjacent to the film rewinding roller after printing has taken place, which, with its edge portion, strikes the surface of the film, “scraping” unused resin from it. It should be noted, however, that in such a machine the film is unwound in one direction only and the scraper that performs the cleaning is only positioned adjacent to the rewinding roller of the film already in use and is shaped to collect the resin for reuse.

A purpose of the present invention is therefore to provide a system for stereolithographic printing that efficiently handles the use of a film or flexible laminar substrate in general.

A further purpose of the present invention is to provide a system for stereolithographic printing that optimally handles the deposition of a plurality of mutually different layers of resin on a film or generally on a flexible laminar substrate in the formation of one and the same object composed of such resins.

An aspect of the present invention relates to a system for stereolithographic printing comprising
a support structure provided with at least a portion of the bottom transparent to the predefined radiation which defines a reference plane on which a three-dimensional object is formed starting from at least one liquid or pasty material sensitive to basic radiation, adapted to be solidified when irradiated by a radiation,
means for generating such radiation in the direction of such reference plane,
a modelling plate which supports and to which the three-dimensional object being formed is constrained, which is able to move the solidified layer according to a direction substantially perpendicular to such plane, so as to allow the last solidified layer of the object to be arranged in a position adjacent to said plane,
means for forming at least one layer of such radiation-sensitive material on such reference plane including at least a portion of a film that can be moved on said plane from one end to the other of said plane and a first feeder of a first radiation-sensitive material on said portion of film,
   characterised in that
such forming means comprise at least a first pair of substantially vertically mobile barriers each arranged in proximity to one of these ends of the plane, the distance between these elements determining the width of the reference plane and such modelling plate moving substantially vertically between the mobile barriers,
such forming means further comprise, externally to the mobile barriers with respect to the plane, a pair of scrapers which strike the film with their tip,
said barriers being movable at least between a first raised position at a height predetermined by the film and a second position in which the lower edge of the barrier is in contact with the film itself,
such film being translatable from one end to the other of said plane in both directions,
such first feeder of such first material on the film being placed in proximity to one of the two barriers, in the space between it and the respective scraper,
The movement of the barriers together with that of the film by adjusting the thickness of the layer of radiation-sensitive material placed on the film in the reference plane and also by adjusting the outflow of the non-solidified material itself from the printing step of one layer, to allow dispensing by the at least one first feeder of a further layer of radiation-sensitive material to be printed.

A further aspect of the present invention relates to a stereolithographic method for the production of a three-dimensional object by superimposing a multiplicity of layers of at least two different radiation-sensitive materials, comprising the following steps:
a1) preparing a layer of a first of the at least two materials on a film by dispensing such material by a first feeder, and translating said film in a first direction away from such first feeder so as to transport said layer on a reference plane from a first end thereof;
b1) selectively irradiating such layer with a radiation on the plane by means (4) for generating such radiation in the direction of such reference plane,
c1) separating such solidified layer from the film by means of a modelling plate which moves reciprocally with respect to such plane,
d1) removing the non-solidified residual material from the film by reversing the translation direction of the film approaching such first feeder, scraping the material from its surface;
e1) sucking such non-solidified material from the film into the first feeder;
a2) preparing a layer of a second of the at least two materials on the film by dispensing such material by a second feeder, and translating said film in a first direction away from such second feeder so as to transport said layer on the reference plane from one end opposite the first;
b2) selectively irradiating such layer with a radiation on the plane by means of said means for generating such radiation in the direction of such reference plane;
c2) separating such solidified layer from the film by means of the modelling plate which moves reciprocally with respect to such plane and constraining such layer to the one previously formed;
d2) removing the residual non-solidified material from the film by reversing the translation direction of the film approaching such second feeder (6′), scraping the material from the surface thereof and
e2) sucking such non-solidified material into the second feeder,
repeating steps a1 to e1 or a2 to e2, choosing which material to dispense for each layer until the complete object is formed by layers.

The features and advantages of the system and method according to the present invention will be more apparent from the following description, which is to be understood as exemplifying and not limiting, with reference to the attached drawings, wherein:

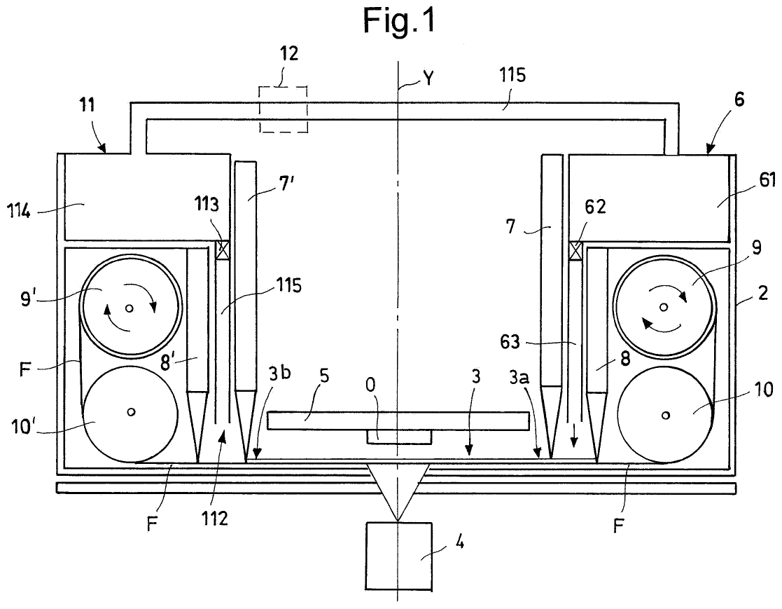

FIG. 1 is a schematic view of the system according to a first embodiment of the present invention;

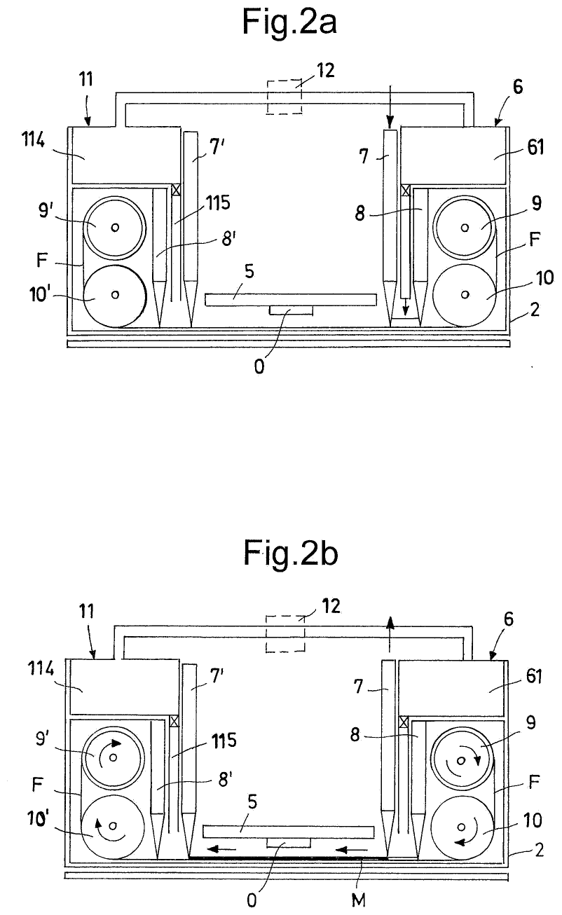

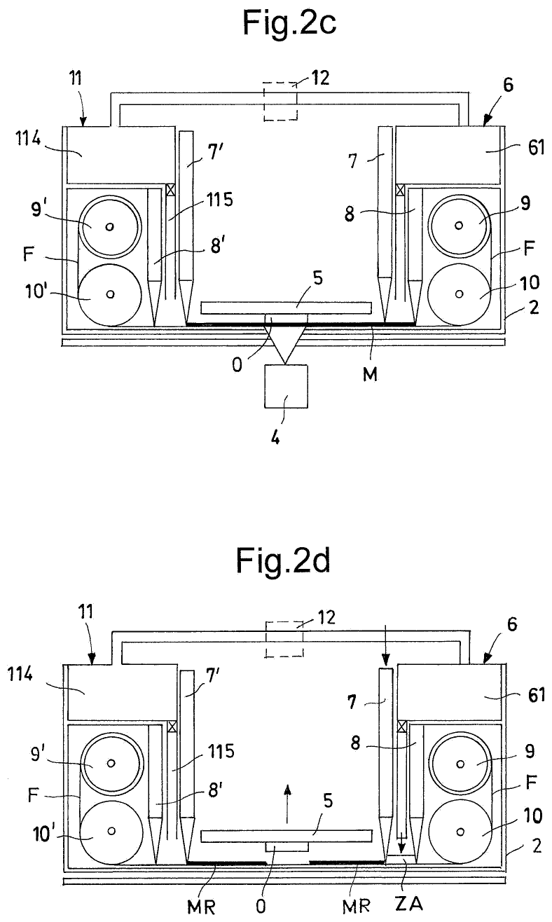

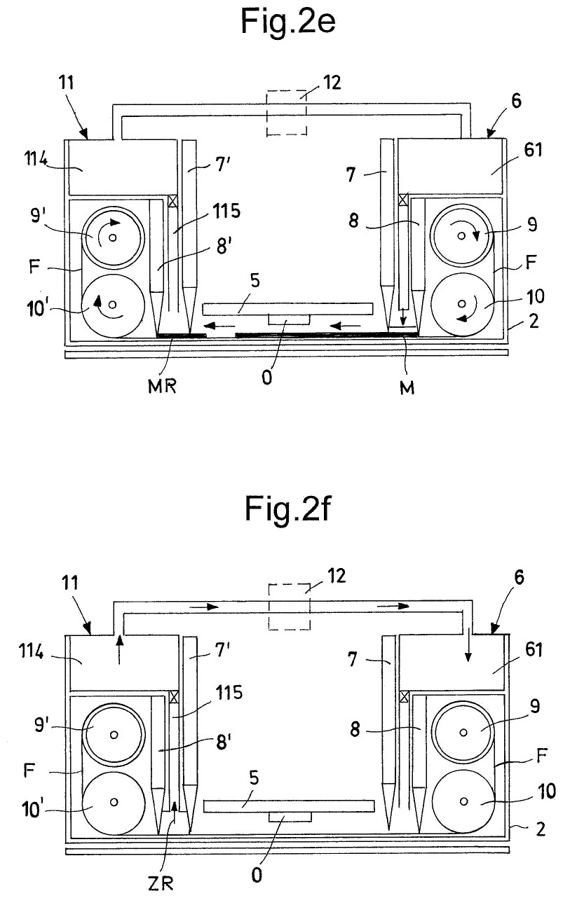

FIGS. 2a-2f illustrate the successive steps of printing the three-dimensional object according to the embodiment of FIG. 1;

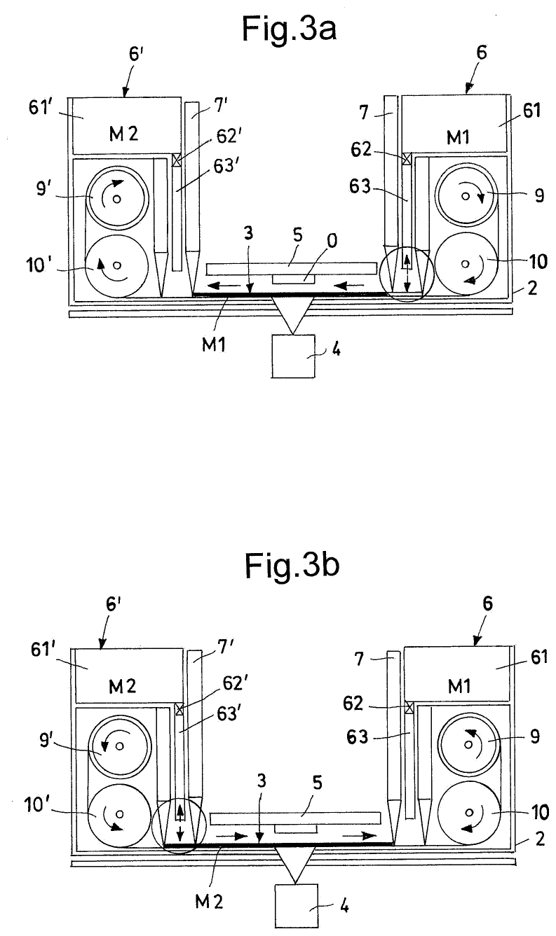

FIGS. 3a and 3b are two schematic views in two different steps of the system according to a second embodiment of the present invention;

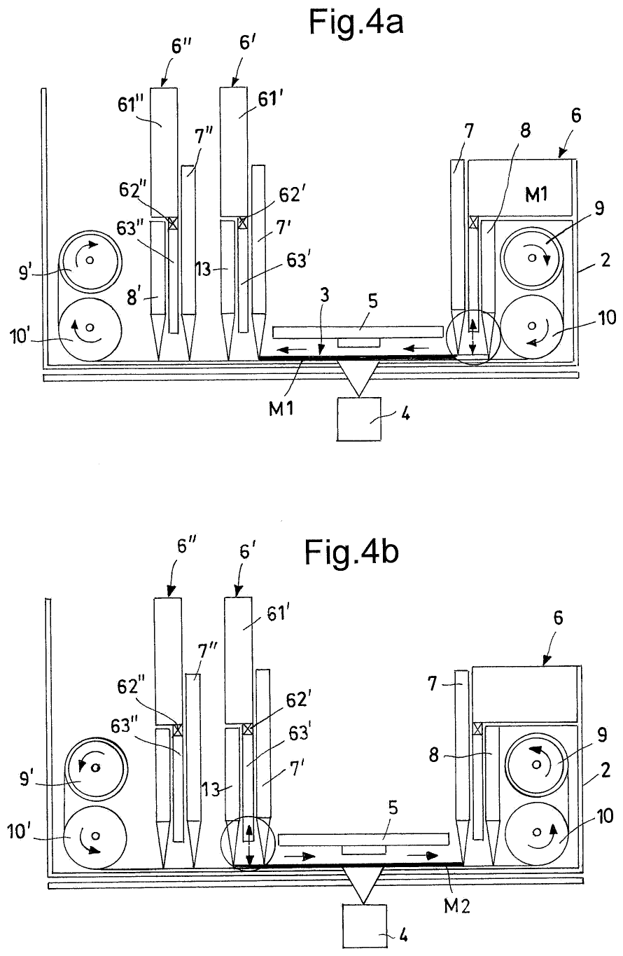

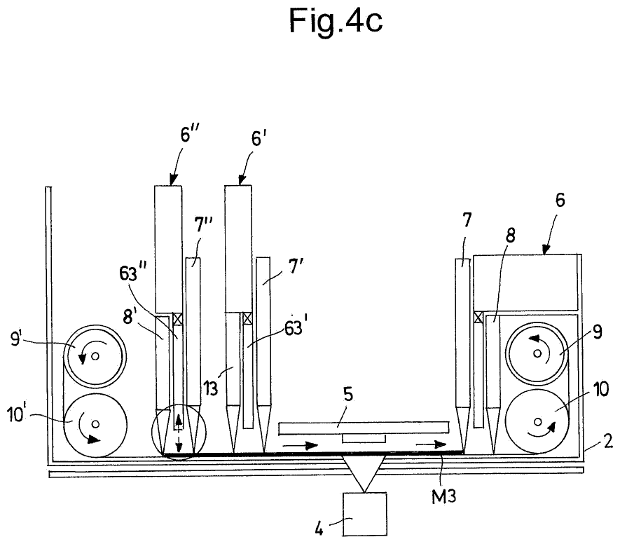

FIGS. 4a-4c are three schematic views in three different steps of the system according to a third embodiment of the present invention.

Referring to the above-mentioned figures, the system for stereolithographic printing of objects according to the present invention comprises, a support structure 2, provided with at least a portion of the bottom transparent to the predetermined radiation, which defines a reference plane 3 on which a three-dimensional object O is formed starting from a liquid or pasty substance sensitive to basic radiation, adapted to be solidified, for example in layers, when irradiated by a radiation which is able to change the state of the material, which may be for example of a luminous, thermal or other type.

The system comprises means 4 for generating such radiation in the direction of such reference plane, a modelling plate 5 which supports and to which the three-dimensional object being formed is constrained, which is able to move the solidified layer according to a direction substantially perpendicular to such plane (along the axis Y shown in the figures), so as to allow the last solidified layer of the object to be arranged in a position adjacent to said plane.

The system further comprises means for forming at least one layer of such radiation-sensitive material on such reference plane including at least a portion of a film F, preferably transparent, that can be moved on said plane from one end 3a to the other 3b of said plane and a first feeder 6 of a first radiation-sensitive material on said portion of film.

Such forming means comprise a first pair of substantially vertical mobile barriers (right 7′ and left 7′) each placed in proximity to one of such ends 3a and 3b of the plane 3. The distance between such elements determines the width of the reference plane. Advantageously, the modelling plate 5 moves vertically between the mobile barriers.

Such barriers are movable at least between a first raised position at a height predetermined by the film and a second position in which the lower edge of the barrier is in contact with the film itself. The barriers are moved by known actuators (not shown in the figure). Such actuators can also allow the height of the barrier to be adjusted, which is predetermined by an electronic processing unit operating the system.

Such forming means further comprise externally to the mobile barriers a pair of scrapers 8 and 8′ which strike the film with their tip.

According to an aspect of the present invention, the film F is translatable with respect to the reference plane from one end 3a to the other end 3b in both directions.

Such forming means further comprise at least one pair of rollers 9 and 9′ that can rotate in either direction, on which the transparent film is reciprocally wound, arranged on opposite sides of said plane 3 outside said scrapers. When the rollers rotate in one direction (e.g. clockwise) they unwind the film from one roller and roll it onto the other, causing the film to move from right to left (as shown in FIG. 1), when they rotate in the opposite direction (anti-clockwise) they move the film from left to right.

The rollers are appropriately driven by known motor means (not shown in the figure). Possibly, such forming means include pulleys 10 and 10′ around which the film F runs and rotates by 90°, so that the film itself can be wound and unwound from the vertical onto the rollers 9 and 9′.

The first feeder 6 of resin onto the film is arranged near one of the two barriers 7 or 7′, in the space between it and the respective scraper 8 or 8′.

In particular, such first feeder comprises a tank for the resin 61 a pump 62 for pumping the resin into a dispensing channel 63 arranged between the barrier 7 or 7′ and the scraper 8 or 8′.

In the embodiment of FIG. 1 on the opposite side of the plane to that presenting the feeder, the system according to the present invention comprises means for recovering 11 the resin not used for printing a layer arranged between the respective barrier and the opposite barrier or scraper. Such recovery means comprise a recovery channel 111, the suction mouth 112 of which is located in proximity to the film, a suction pump 113 and a recovery tank 114. Such recovery means also include an additional transfer channel 115 that returns the recovered resin to the feeder tank 61. Advantageously, one or more devices 12 for filtering the resin from impurities can be provided along this recovery channel.

Generally, the impurities generated during the printing process are characterised by parts of material solidified during previous steps. Causes may be, for example: (a) detachment of parts of the object in formation, (b) detachment of parts of the support structures, (c) spontaneous solidification of the material, (d) external contamination of the material.

The movement of the barriers 7 and 7′ together with that of the film adjusts the thickness of the layer of radiation-sensitive material placed on the film in the reference plane and also adjusts the outflow of the non-solidified material itself from the printing step of one layer, to allow dispensing by the at least one first feeder 6 of a further layer of radiation-sensitive material to be printed.

It should be noted that for the purposes of the present invention in the illustrated FIGS. 1 2a-2f, the first feeder 6 is positioned to the right of the reference plane and the recovery device 11 is positioned to the left of the reference plane, but equivalently their position may be reversed.

The system in the embodiment shown in FIG. 1 operates as follows.

In a first step, the radiation-sensitive material is dispensed from the first feeder 6 while keeping the adjacent barrier 7 lowered; this is done by operating the pump 62 and causing it to pump from the channel 63 to the film in a feed zone ZA between the barrier 7 and the scraper 8 (FIG. 2a). At this stage, the film is preferably still.

Next, the barrier 7 is lifted and the film F is moved; this is done by rotating the rollers 9 and 9′ until a layer of material M is evenly distributed on the film in the reference plane (FIG. 2b).

The next step is to print the layer of radiation-sensitive material on the plane; this is done by lowering the modelling plate and irradiating the plane area by the generation means 4 located below the plane itself, solidifying the radiation-sensitive material in the area corresponding to the design according to the print programme stored in the system (FIG. 2c).

In the next step, the modelling plate 5, to which the solidified layer has been constrained, is lifted. Advantageously, by lowering the barrier 7, it is possible, during this step, through the feeder 6, to supply additional radiation-sensitive material in the area comprised between the barrier 7 adjacent to the feeder and the scraper 8, which can then be used to print the next layer. In fact, in this condition, this zone is isolated from the reference plane (FIG. 2d).

In the next step, the barrier 7′ opposite the barrier 7 adjacent to the feeder is lifted and the film F is translated until the residual radiation-sensitive material MR not solidified by the print is brought into a recycling zone ZR, between this barrier 7′ and the scraper 8′. The scraper 8′ not only stops the material in this recycling zone, but also cleans residues on the film surface, preventing the film being rewound onto the roller 9′ from being contaminated and making rewinding difficult. At the same time, the barrier 7 adjacent to the feeder 6 can also be raised, so that another layer of homogeneous radiation-sensitive material can be regenerated on the film F for printing the next layer (FIG. 2e).

Finally, the residual radiation-sensitive material is recovered from the recovery zone

ZR via the recovery channel 111, the suction mouth 112 of which is arranged in proximity to the film, under the action of the suction pump 113 and brought into the recovery tank 114. From here, the radiation-sensitive material is returned via the transfer channel to the resin feed tank 61.

A specific cleaning and/or rewinding step (complete or partial) of the film on one of the rollers 9 or 9′ can be provided between one printing step and the next, or at any appropriate moment between the processes.

In certain applications, the need arises to form three-dimensional objects composed of different materials. For example, in the field of dentistry, dental prostheses made of resin need to be externally a colour as close as possible to the original tooth they are going to replace, while internally they may be made of a different resin.

The hardening of the base material layer is only carried out in the areas corresponding to the volume of the object stored in the digital model of a corresponding layer of the object to be manufactured.

Advantageously, such a digital model can be made by means of known digital drawing processing and creation techniques. Additionally, the creation of such a digital model can be performed by means of a scanning device of a three-dimensional prototype of the object to be manufactured. Preferably, but not necessarily, the processing of such a digital model according to known techniques could include the addition, to the three-dimensional model of the object, of a support structure allowing for greater stability of the growing object during the operations of the method according to the invention. The aforementioned support structure becomes an integral part of the three-dimensional object made by the stereolithography machine and is separated from the rest of the object after its creation.

The aforementioned radiation generation means include projector technologies such as DLP (Digital Light Processing), LCD (Liquid Crystal Display), LCOS (Liquid Crystals on Silicon) and D-ILA (Direct Drive Image Light Amplifier), as well as electron beam emitters (EBM) and other sources of radiation.

A further embodiment of the invention is illustrated in FIGS. 3a and 3b, comprising a second feeder 6′ for a second radiation-sensitive material M2 arranged in proximity to the barrier 7′ opposite the first feeder, outside of it with respect to the reference plane (to the left as illustrated in such figures) and comprised between that barrier 7′ and the respective scraper 8′. This second feeder 6′ is advantageously positioned in place of the recovery means 11.

Such second feeder comprises a tank for a second radiation-sensitive material 61′, a reversible pump 62′ for pumping or sucking the radiation-sensitive material into a dispensing channel 63′ arranged adjacent to the barrier 7′. This second feeder 6′ advantageously contains a second radiation-sensitive material which may be of a different type from the first radiation-sensitive material M1 contained in the tank of the first feeder 6.

Similarly, the first feeder also comprises a reversible pump 62 for pumping or sucking radiation-sensitive material into a delivery channel 63 arranged adjacent to the barrier 7.

In this embodiment, reversible pumps are necessary to allow the system to operate with two different types of materials. In fact, in order to handle the change of material on the reference plane, it is necessary to suck the remaining material from the previous step of one layer and then lay the next layer with the other type of material. The motion of the rollers and consequently of the film F and the position of the mobile barriers is determined on the basis of which of the feeders delivers the radiation-sensitive material to be laid and printed. In particular, in the arrangement of FIG. 3a when the radiation-sensitive material is dispensed by the first feeder 6 the translation of the film is from right to left, whereas when the radiation-sensitive material is dispensed by the second feeder 6′ the translation of the film is from left to right.

In this embodiment, the steps for performing the stereolithography method for producing a three-dimensional object by superimposing a multiplicity of layers of at least two different radiation-sensitive materials comprise
preparing a layer of a first of the at least two materials on a film (F) by dispensing such material by a first feeder (6), and (in the meantime or subsequently) translating said film in a first direction away from such first feeder (6) so as to transport said layer on a reference plane (3) from a first end (3a) thereof (as indicated by the arrows in FIG. 3a);
selectively irradiating such layer with light radiation on the plane by means (4) for generating such radiation in the direction of such reference plane,
separating such solidified layer from the film by means of a modelling plate (5) which moves reciprocally with respect to such plane,
removing the non-solidified residual material from the film by reversing the translation direction of the film approaching such first feeder (6), scraping the material from its surface;
sucking such non-solidified material from the film into the first feeder;
preparing a layer of a second of the at least two materials on the film (F) by dispensing such material by a second feeder (6′), and (at the same time or subsequently) translating said film in a first direction away from such second feeder (6′) so as to transport said layer on the reference plane (3) from one end (3b) opposite the first (3a), (as indicated by the arrows in FIG. 3b);
selectively irradiating this layer with light radiation on the plane by means of said means (4) for generating said radiation in the direction of such reference plane;
separating such solidified layer from the film by means of the modelling plate (5) which moves reciprocally with respect to such plane and constraining such layer to the one previously formed;
removing the residual non-solidified material from the film by reversing the translation direction of the film approaching such second feeder (6′), scraping the material from the surface thereof and
sucking such non-solidified material into the second feeder.

The previous steps can be repeated cyclically by choosing which material to dispense in each individual layer until the complete object is formed in layers.

Furthermore, the delivery of such material from the feeders 6 and 6′, and its translation (simultaneous or subsequent) may depend on the type and consistency of the material.

When the first material is dispensed by the first feeder 6, the barrier 7 adjacent to the feeder is raised and adjusts the height of the layer of material to be formed on the film F placed on the reference plane 3, while the opposite barrier 7′ may remain in contact with the film, blocking the flow of material. Alternatively, the barrier 7′ can also be lifted and the material flow is blocked further on by the scraper 8′, which always remains in contact with the film. This starts the accumulation of the material itself in the corresponding recovery zone. This technique should help to maintain a constant thickness of material in the film, considering that both the barriers 7 and 7′ would rise by the same amount.

Furthermore, when the object is made of two different materials, a same layer of the object may be composed of two or more materials. In this case, the deposition of the first and second materials on the same layer and their solidification is enabled by the appropriate positioning of the modelling plate. In fact, after the portion of the layer consisting of the first material has been placed on the film and solidified, the portion of the layer consisting of the second material is placed on the film and selectively solidified by positioning the modelling plate so that the two portions of the layer are aligned with each other in the right position to construct the object.

Then, following the deposition of the second material in the film, the modelling platform positions itself in the position where the portion of the first material has solidified, thus allowing the generation of a layer composed of two (or more) materials arranged in the same flat section of the object to be formed and each selectively irradiated.

Likewise, when the second material is dispensed by the second feeder 6′, the barrier 7′ adjacent to the feeder is raised and adjusts the height of the layer of material to be formed on the film F placed on the reference plane 3, while the opposite barrier 7 is in contact with the film, blocking the flow of material.

In analogy to what is described and illustrated in the embodiment of FIGS. 3a and 3b, in certain applications, the need arises to form three-dimensional objects composed of more than two different materials.

The steps of deposition, irradiation, separation and recovery of two or more materials can be performed sequentially by repositioning the modelling plate 5 in the same position along the axis Y, in order to generate a layer composed of two or more selectively solidified materials in the same thickness of the layer.

Examples may be:
a first material for the object, and a second material for the support structures;
a first material for the rigid parts of the object, a second material for the flexible parts of the object;
a first material for the insulating parts of the object, a second material for the conductive parts of the object;
a first material for the object, and a second water-soluble material for the support structures for easy removal thereof;
a first coloured material for specific parts of the object, a second coloured material for specific parts of the object.

FIGS. 4a, 4b and 4c illustrate a further embodiment of the invention, comprising a second feeder 61 of radiation-sensitive material arranged on the opposite side of the plane from the first feeder 6, and a third feeder 6′ arranged externally to this second feeder 6′ with respect to the reference plane 3.

Both the second feeder and the third feeder comprise a respective tank 61′ or 61″ for a second M2 and for a third M3 radiation-sensitive material, a reversible pump 62′ or 62″ for pumping or suctioning the radiation-sensitive material into a delivery channel 63′ or 63″.

Also in this embodiment, reversible pumps are necessary to allow the system to operate with at least two different types of materials. In fact, in order to handle the change of material on the reference plane, it is necessary to suck the remaining material from the previous step of one layer and then lay the next layer with the other type of material.

In this embodiment, the means for forming at least one layer of radiation-sensitive material comprise a further mobile barrier 13 arranged between the dispensing/suction channel 63′ of the second feeder 6′ and the barrier 7″ of the third feeder. The presence of this additional mobile barrier is necessary to allow the dispensing/suction of material from the third feeder 6″, a condition in which both the barrier 7′ adjacent to the second feeder and this additional barrier are raised to allow the material to pass through.

In this three-source embodiment, the following steps must be added to the steps indicated in the method according to the second (two-source) embodiment:
preparing a layer of a third of the at least two materials on the film (F) by dispensing such material by a third feeder (6′), and (at the same time or subsequently) translating said film in a first direction away from such third feeder (6′) so as to transport said layer on the reference plane (3) from one end (3a or 3b);
selectively irradiating this layer with light radiation on the plane by means of said means (4) for generating said radiation in the direction of such reference plane;
separating such solidified layer from the film by means of the modelling plate (5) which moves reciprocally with respect to such plane and constraining such layer to the one previously formed;
removing the residual non-solidified material from the film by reversing the translation direction of the film approaching such third feeder (6″), scraping the material from the surface thereof and
sucking such non-solidified material into the third feeder.

The third feeder 6″ has been depicted in FIGS. 4a-4c adjacent (on the same end as the plane 3) to the second feeder 6″, but equivalently it can be placed adjacent to the first feeder by placing the additional barrier 12 on that side.

Finally, embodiments which provide for additional feeders for different radiation-sensitive materials, always placed on either side of the reference plane 3, are included within the scope of the present invention, following the same logical scheme.

1. System for stereolithographic printing comprising
a support structure (2) provided with at least a portion of the bottom transparent to the predefined radiation which defines a reference plane (3) on which a three-dimensional object is formed starting from at least one liquid or pasty material sensitive to basic radiation, adapted to be solidified when irradiated by a radiation,
means (4) for generating such radiation in the direction of such reference plane,
a modelling plate (5) which supports and to which the three-dimensional object being formed is constrained, which is able to move the solidified layer according to a direction substantially perpendicular to such plane, so as to allow the last solidified layer of the object to be arranged in a position adjacent to said plane,
means for forming at least one layer of such radiation-sensitive material on such reference plane including at least a portion of a film (F) that can be moved on said plane from one end (3a) to the other (3b) of said plane and a first feeder (6) of a first radiation-sensitive material on said portion of film, characterised in that
said forming means comprise at least a first pair of substantially vertically mobile barriers (7,7′) each arranged in proximity to one of these ends (3a, 3b) of the plane (3), the distance between these elements determining the width of the reference plane and said modelling plate (5) moving substantially vertically between the mobile barriers,
said forming means further comprise, externally to the mobile barriers with respect to the plane (3), a pair of scrapers (8,8′) which strike the film with their tip,
said barriers being movable at least between a first raised position at a height predetermined by the film and a second position in which the lower edge of the barrier is in contact with the film itself,
said film being translatable from one end (3a) to the other (3b) of said plane in both directions,
such first feeder (6) of such first material on the film being placed near one of the two barriers (7,7′), in the space between it and the respective scraper (8,8′),
The movement of the barriers together with that of the film by adjusting the thickness of the layer of radiation-sensitive material placed on the film in the reference plane and also by adjusting the outflow of the non-solidified material itself from the printing step of one layer, to allow dispensing by the at least one first feeder (6) of a further layer of radiation-sensitive material to be printed.

2. System according to claim 1, wherein such forming means comprise at least one pair of rollers (9,9′) which can rotate in both rotation directions, on which the radiation transparent film transparent is mutually wound, arranged at opposite sides of said plane (3) externally to said scrapers (8,8′).

3. System according to claim 1, wherein said first feeder comprises a tank for the resin (61), a pump (62) for pumping the resin into a dispensing channel (63) arranged between the barrier (7 or 7′) and the scraper (8 or 8′).

4. System according to claim 1, comprising recovery means (11) of the material on the film not used for printing a layer, arranged on the opposite side of the plane (3) to that which has the first feeder (6).

5. System according to claim 4, wherein said recovery means comprise a recovery channel (111), whose suction mouth (112) is arranged in proximity to the film, a suction pump (113), a recovery tank (114) and a transfer channel (115) which brings the recovered resin back into the feeder tank (61).

6. System according to claim 2, wherein said forming means comprise pulleys (10,10′) around which the film (F) runs and rotates by 90° so as to allow the rolling and unrolling from the vertical of the film itself on the rollers.

7. System according to claim 1, comprising a second feeder (6′) of a second radiation-sensitive material, different from the first, arranged in proximity to the barrier (7′) opposite that adjacent to the first feeder (6), arranged between such barrier (7′) and the respective scraper (8′).

8. System according to claim 7, wherein said second feeder comprises a tank for a second radiation-sensitive material (61′) a reversible pump (62′) for pumping or sucking the radiation-sensitive material into a dispensing channel (63′) arranged adjacent to the barrier (7′).

9. System according to claim 8, wherein the pump of the first feeder is a reversible pump (62) for pumping or sucking the radiation-sensitive material from the dispensing channel (63).

10. System according to claim 7, comprising a third feeder (6″) of a third radiation-sensitive material, different from the first and the second, arranged externally to such second feeder (6′) with respect to the reference plane (3).

11. System according to claim 10, wherein the third feeder comprises a tank for a third radiation-sensitive material (61″) a reversible pump (62″) for pumping or sucking the radiation-sensitive material into a dispensing channel (63″).

12. System according to claim 11, wherein the means for forming at least one layer of radiation-sensitive material comprise a further mobile barrier (13) arranged between the dispensing/suction channel (63′) of the second feeder (6′) and the barrier (7″) adjacent to the third feeder.

13. Stereolithographic method for the production of a three-dimensional object through the superposition of a multiplicity of layers of at least two different radiation-sensitive materials comprising the following steps:
a1) preparing a layer of a first of the at least two materials on a film (F) by dispensing such material by a first feeder (6), and translating said film in a first direction away from such first feeder (6) so as to transport said layer on a reference plane (3) from a first end (3a) thereof;
b1) selectively irradiating such layer with a radiation on the plane by means (4) for generating such radiation in the direction of such reference plane,
c1) separating such solidified layer from the film by means of a modelling plate (5) which moves reciprocally with respect to such plane,
d1) removing the non-solidified residual material from the film by reversing the translation direction of the film approaching such first feeder (6), scraping the material from its surface;
e1) sucking such non-solidified material from the film into the first feeder;
a2) preparing a layer of a second of the at least two materials on the film (F) by dispensing such material by a second feeder (6′), and translating said film in a first direction away from such second feeder (6′) so as to transport said layer on the reference plane (3) from one end (3b) opposite the first (3a);
b2) selectively irradiating such layer with a radiation on the plane by means of said means (4) for generating such radiation in the direction of such reference plane;
c2) separating such solidified layer from the film by means of the modelling plate (5) which moves reciprocally with respect to such plane and constraining such layer to the one previously formed;
d2) removing the residual non-solidified material from the film by reversing the translation direction of the film approaching such second feeder (6′), scraping the material from the surface thereof
e2) sucking such non-solidified material into the second feeder; repeating steps a1 to e1 or a2 to e2, choosing which material to dispense for each layer until the complete object is formed by layers.
